(19) United States
(12) Patent Application Publication
(10) Pub. No.: US 2026/0332423 A1
(43) Pub. Date: Oct. 22, 2026

(54) PREDICTIVE ACTUATION GATING FOR A HETEROGENEOUS PHYSICAL ARTIFICIAL INTELLIGENCE SWARM

(71) Applicant: Dorian Catwright, San Jose, CA (US)

(72) Inventor: Dorian Catwright, San Jose, CA (US)

(21) Appl. No.: 19/640,711

(22) Filed: Apr. 7, 2026

Related U.S. Application Data
(63) Continuation-in-part of application No. 19/638,074, filed on Apr. 2, 2026.

(51) Int. Cl. H04L 9/32; G06N 3/008

(52) U.S. Cl. CPC H04L 9/3234; G06N 3/008

(57) ABSTRACT

Swarm consensus actuation gating, shared-context arbitration, and cryptographic motor unlocking in physical artificial intelligence systems are disclosed. A plurality of physical artificial intelligence systems generate local candidate actions and exchange shared-context information including predicted occupancy, trajectories, actuation envelopes, load states, object states, or intent descriptors. A consensus engine evaluates whether a combined action set satisfies cooperative constraints including safety, collision, resource, timing, load-sharing, or policy constraints. A proposing system broadcasts a candidate action to peer systems that independently evaluate the action and return authorization outputs or cryptographic validation tokens. Physical actuation is released only upon satisfaction of an authorization condition. A shared future occupancy or object-state representation may be used to authorize or deny simultaneous actuation. A cryptographically secured actuator controller unlocks actuators only after verification that a threshold authorization condition has been satisfied.

### CROSS-REFERENCE TO RELATED APPLICATIONS

The present application claims priority under 35U.S.C. § 120 as a continuation-in-part of U.S. patent application Ser. No. 19/638,074, filed Apr. 2, 2026, by Dorian Cartwright and entitled PREDICTIVE ACTUATION GATING IN PHYSICAL ARTIFICIAL INTELLIGENCE, the contents of which are hereby incorporated by reference in their entirety.

### FIELD OF THE INVENTION

The present disclosure relates generally to computers and physical artificial intelligence, and more specifically, to intercepting candidate actions of a swarm of physical artificial intelligence from individual decision models and selectively validating such actions, before physical execution by actuators.

### BACKGROUND

Physical artificial intelligence systems increasingly rely on learned policies, vision-language-action models, language-guided planners, reinforcement learning policies, diffusion policies, imitation learning controllers, trajectory generators, and other predictive or generative control architectures to propose candidate actions for robots, humanoids, drones, autonomous mobile robots, autonomous vehicles, industrial manipulators, warehouse systems, and other embodied systems.

In single-agent deployments, candidate actions may be evaluated by local predictive validators before motor release in order to reduce risks such as collision, instability, unsafe force application, object loss, grip slip, fracture, or unsafe human proximity. A parent architecture may intercept a candidate action before motor release and treat the candidate action as a proposal subject to validation rather than as an immediately executable motor command.

However, as physical artificial intelligence scales from isolated operation to multi-agent or swarm operation, individually acceptable local actions may become unsafe, inefficient, or impermissible in combination. A first robot arm may be locally safe to move into a shared workcell while a second robot arm is also locally safe to enter the same workcell, yet the simultaneous action set may create collision, obstruction, deadlock, excessive shared-object loading, unstable handoff timing, unsafe interference, or mutually exclusive workspace violation.

Similar issues arise where multiple humanoids, drones, autonomous vehicles, mobile robots, tools, or hybrid machine teams operate in overlapping spaces, near shared doors, hallways, intersections, storage aisles, joint fixtures, conveyor interfaces, staging zones, or jointly manipulated objects. In such settings, safety and task success may depend on the combined effect of simultaneous or near-simultaneous actions rather than on local motion validity alone.

Conventional safety systems often validate one machine in isolation or rely on simplistic collision zones, serialized scheduling, emergency stops, or rigid supervisory control. Such approaches do not adequately account for dynamically changing local plans, predicted future occupancies, tool envelopes, shared-object states, cross-agent timing dependencies, right-of-way conditions, resource exclusivity, or shared policy constraints among a plurality of autonomous agents.

More recent decentralized swarm-robotics and multi-robot navigation systems have improved scalability of local planning and distributed execution, including decentralized path generation, trajectory optimization, reinforcement-learning-based navigation, graph-based policy coordination, and communication-constrained swarm planning. However, such systems principally focus on generation of feasible paths, trajectories, or navigation policies, rather than on whether a locally generated candidate action should be physically released for execution when evaluated against a combined simultaneous action set involving multiple physical artificial intelligence systems.

A further deficiency of such decentralized planning systems is that a locally feasible motion output does not necessarily account for cooperative release conditions such as shared future occupancy, carried-object envelope interaction, staged handoff readiness, cooperative load sharing, force-balance preservation, or mutually exclusive workspace ownership. As a result, individually acceptable local actions may remain unsafe, inefficient, or impermissible in combination, even after decentralized path generation, collision-avoidance planning, or local policy selection has occurred.

Another deficiency arises because decentralized multi-agent control often relies on local sensing, local learned policies, local maps, or partially observed world models. Even where a decentralized policy improves obstacle avoidance or swarm scalability, its output may remain vulnerable to blind spots, stale local state, sensing degradation, communication limits, adversarial manipulation, compromised local memory, or localized model overconfidence. Existing decentralized swarm-planning systems do not adequately require independent peer-side validation of a candidate physical action from distinct sensor perspectives, distinct local world models, or distinct simulation pipelines before release of physical actuation.

Still another deficiency is that some distributed multi-robot systems include safety-oriented or security-oriented policy enhancements, but such approaches still operate principally at the policy-selection, path-selection, or trajectory-generation layer. They do not adequately provide a hard pre-actuation barrier that physically prevents actuator release until a required cooperative authorization condition is satisfied. In particular, existing decentralized navigation and swarm-planning systems do not adequately disclose a release architecture in which one or more actuator pathways remain locked pending satisfaction of threshold peer authorization, shared-context arbitration, or continued permissibility of a shared future occupancy representation.

Centralized control can partially coordinate multiple machines, but centralized architectures may introduce latency, bandwidth bottlenecks, stale-state problems, single points of failure, and reduced autonomy at the edge. Conversely, purely local decision-making can lead to inconsistent release decisions, race conditions, unsafe simultaneous actuation, and execution based on incomplete or overconfident local world models.

A further deficiency arises where multi-agent systems require authorization of simultaneous actuation based not only on present geometry but also on predicted future occupancy, evolving load distribution, shared-object stability, cooperative force application, staged handoff readiness, mutually exclusive workspace ownership, or policy-defined priority relationships.

Still another deficiency arises in safety-critical environments where one or more agents may experience localized sensing degradation, occlusion, drift, stale world-state estimates, adversarial manipulation, compromised memory, or communication anomalies. In such conditions, a release decision based solely on one agent's local validator may be unsafe or vulnerable to a bad actor.

There accordingly exists a need for a distributed or shared-context actuation gate that extends predictive actuation validation from a single machine to a plurality of physical artificial intelligence systems, and that authorizes or denies local actuation based on a combined action set, shared future occupancy, shared object-state, cooperative constraints, peer validation, and, in some embodiments, distributed cryptographic consensus or cryptographically verifiable peer authorization.

### SUMMARY

The present disclosure provides systems, methods, and computer program products for swarm consensus actuation gating, shared-context arbitration, and cryptographic motor unlocking in physical artificial intelligence systems. In various embodiments, the disclosed architecture operates at a physical release-control layer after one or more local candidate actions have already been generated by one or more decision models, planners, learned policies, or decentralized swarm-control systems, and determines whether such candidate actions may actually be released for physical execution.

In a first embodiment, a plurality of physical artificial intelligence systems generate respective local candidate actions, each local candidate action being treated as a provisional action proposal rather than an immediately executable motor command. The plurality of physical artificial intelligence systems exchange shared-context information associated with the respective local candidate actions, and a consensus engine determines whether a combined action set associated with the plurality of local candidate actions satisfies one or more cooperative constraints before simultaneous actuation is released for one or more of the plurality of physical artificial intelligence systems.

In a second embodiment, the shared-context information includes one or more of predicted occupancy, future trajectory, local world-state projection, actuation envelope, tool envelope, load-state projection, object-state projection, timing window, right-of-way state, zone claim, intent descriptor, peer readiness, uncertainty score, or combinations thereof. In some embodiments, the one or more cooperative constraints include one or more of collision constraints, maintained clearance constraints, zone exclusivity constraints, mutually exclusive workspace constraints, object-stability constraints, load-sharing constraints, handoff readiness constraints, force-balance constraints, synchronized timing constraints, right-of-way constraints, policy constraints, communication-confirmation constraints, or combinations thereof.

In a third embodiment, the system maintains a shared future occupancy representation for a plurality of physical artificial intelligence systems and uses the shared future occupancy representation to authorize or deny simultaneous actuation. In some embodiments, the shared future occupancy representation includes predicted future positions, swept volumes, time-indexed occupancy cells, probabilistic occupancy densities, path-reservation intervals, or combinations thereof.

In a fourth embodiment, a plurality of physical artificial intelligence systems jointly manipulating a common object are required to satisfy a load-sharing or object-stability authorization condition before releasing local actuation commands. In some embodiments, the authorization condition is determined using one or more of predicted load distribution, force balance, object pose stability, grip-point configuration, torsional imbalance, handoff readiness, or combinations thereof.

In a fifth embodiment, a proposing physical artificial intelligence system generates a candidate action and broadcasts a validation request associated with the candidate action to a plurality of peer physical artificial intelligence systems, wherein the candidate action is intercepted prior to local motor release. The peer physical artificial intelligence systems independently evaluate the candidate action utilizing respective sensor geometries, spatial perspectives, local world models, predicted occupancy maps, simulation pipelines, or combinations thereof, and generate peer authorization outputs.

In a sixth embodiment, a threshold authorization condition is applied to the peer authorization outputs before actuation associated with the candidate action is released. In some embodiments, the threshold authorization condition comprises a quorum, strict majority, weighted threshold, safety-class threshold, role-based threshold, Byzantine fault-tolerant threshold, or another threshold condition.

In a seventh embodiment, the peer authorization outputs comprise cryptographically verifiable authorization tokens, signed validation messages, authenticated votes, or other verifiable authorization artifacts. A cryptographically secured actuator controller aggregates the received authorization outputs and physically unlocks one or more actuators only when a required threshold authorization condition is satisfied.

In an eighth embodiment, where a combined action set or proposed local candidate action is not authorized, one or more local candidate actions are delayed, synchronized, staged, modified, decomposed, rerouted, reordered, partially released, or rejected. In some embodiments, release may be conditioned on continued permissibility of a shared future occupancy representation, peer readiness confirmation, reduced speed, reduced force, increased clearance, or other execution constraints.

In a ninth embodiment, the consensus engine is implemented in a distributed manner across the plurality of physical artificial intelligence systems, in an edge coordinator, in a supervisory controller, in a shared world-model service, or in a hybrid combination thereof.

In a tenth embodiment, release decisions, predicted cooperative consequences, predicted tactile consequences, measured execution outcomes, policy conflicts, failed authorizations, and peer-evaluation outcomes are logged and used to improve one or more predictive validators, consensus policies, action-generation policies, world models, risk thresholds, or arbitration policies.

Many other variations are possible.

### BRIEF DESCRIPTION OF THE DRAWINGS

The present disclosure will be understood more fully from the detailed description given below and from the accompanying drawings of various embodiments of the disclosure.

FIG. 1A is a perspective diagram illustrating an individual physical artificial intelligence system comprising a plurality of physical artificial intelligence systems or agents operating in a shared environment, according to an embodiment.

FIG. 1B is a perspective diagram illustrating cooperative physical artificial intelligence system comprising a plurality of physical artificial intelligence systems or agents operating in a shared environment, according to an embodiment.

FIG. 1C is a perspective diagram illustrating a swarm of physical artificial intelligence systems comprising a plurality of physical artificial intelligence systems or agents operating in a shared environment, according to an embodiment.

FIG. 2 is a more detailed block diagram illustrating a local actuation validation subsystem, according to an embodiment.

FIG. 3 is a more detailed block diagram illustrating a consensus engine, according to an embodiment.

FIG. 4A is a block diagram illustrating the consensus engine interacting with other components for processing local candidate actions in view of shared local actions, according to some embodiments.

FIG. 4B is a block diagram illustrating the consensus engine processing locally validated actions from a plurality of systems, according to an embodiment.

FIG. 4C is a block diagram illustrating the consensus engine processing a variety of data including local candidate actions, including locally validated actions a candidate actions that have been locally validated, globally validated candidate actions as local candidate actions that have previously been swarm validated, according to an embodiment.

FIG. 5 is a flow diagram illustrating a method 500 for cryptographic consensus actuation gating in a distributed swarm of physical artificial intelligence systems, according to an embodiment.

FIG. 6 is a flow diagram illustrating a method 600 for cooperative actuation gating among a plurality of physical artificial intelligence agents, according to an embodiment.

FIG. 7 is a flow diagram illustrating a method 700 for shared future occupancy authorization, according to an embodiment.

FIG. 8 is a flow diagram illustrating a method 800 for shared object-state and load-sharing authorization, according to an embodiment.

FIG. 9 is a flow diagram illustrating a method 1000 for branching, staged, and conditional release control, according to an embodiment.

FIG. 10 is a block diagram of a computing environment for implementing components, according to an embodiment.

### DETAILED DESCRIPTION

The description below provides methods, computer program products, and systems in which candidate actions for physical artificial intelligence systems (e.g., in a swarm of humanoid robots) are intercepted before actuation and evaluated not only with local predictive models but also in view of cooperative, shared-context, and consensus-based conditions in multi-agent (e. g., autonomous agents) environments.

The present disclosure extends predictive actuation gating beyond a single physical artificial intelligence system. In the disclosed embodiments, local action generation remains separated from physical execution so that a candidate action is treated as a proposal subject to one or more layers of validation, authorization, and arbitration before motor release.

In some embodiments, the disclosed architecture supplements local predictive validation with a cooperative authorization layer that evaluates a combined simultaneous action set. In some embodiments, the disclosed architecture operates after one or more candidate actions have already been generated by one or more decentralized planners, learned navigation policies, reinforcement-learning controllers, graph-based coordination policies, optimization engines, or other decision models, such that the disclosed architecture is planner-agnostic and functions as a physical release-control layer rather than as a path-generation layer. In some embodiments, this cooperative authorization layer is implemented by a distributed consensus engine. In some embodiments, the cooperative authorization layer uses a shared future occupancy map, shared object-state representation, or shared load-state representation. In still other embodiments, the cooperative authorization layer uses peer-side independent evaluation and cryptographically verifiable peer authorization outputs.

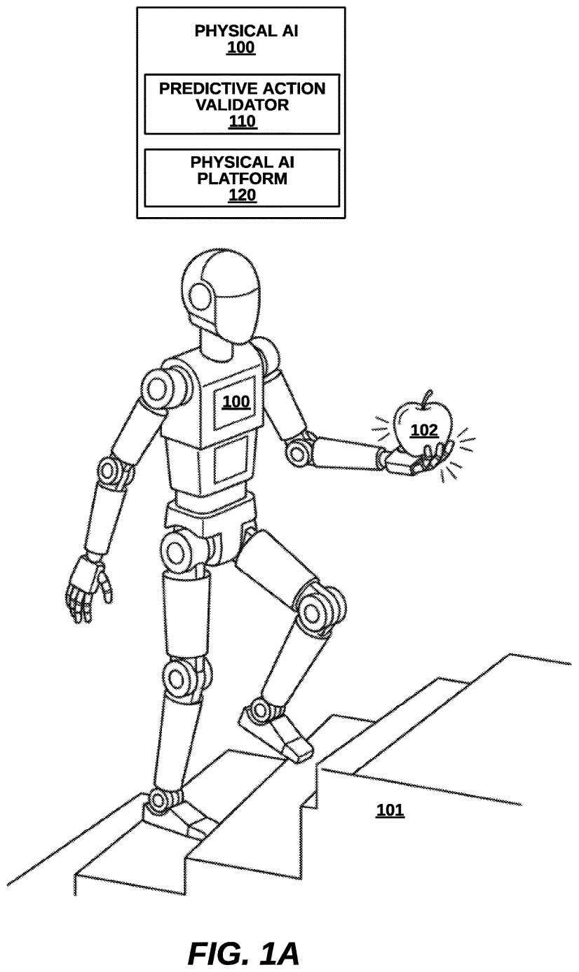

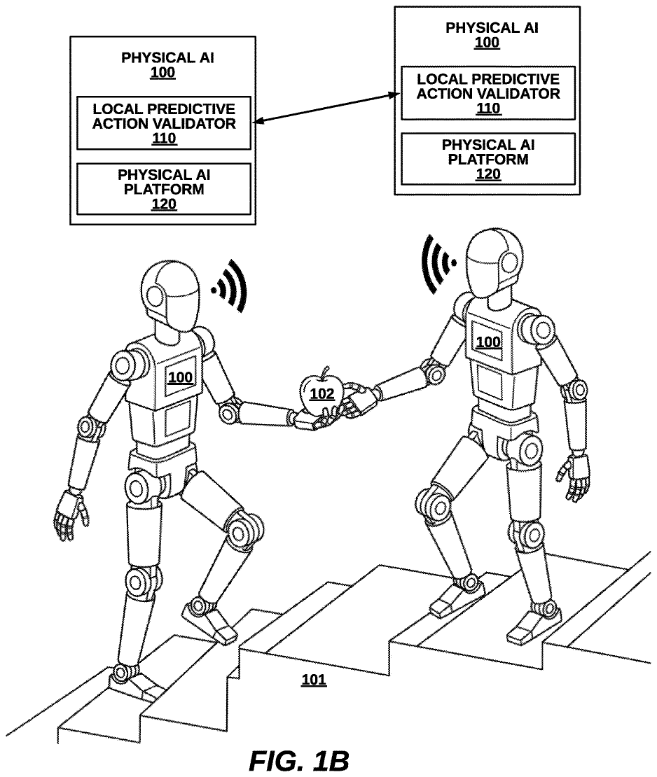

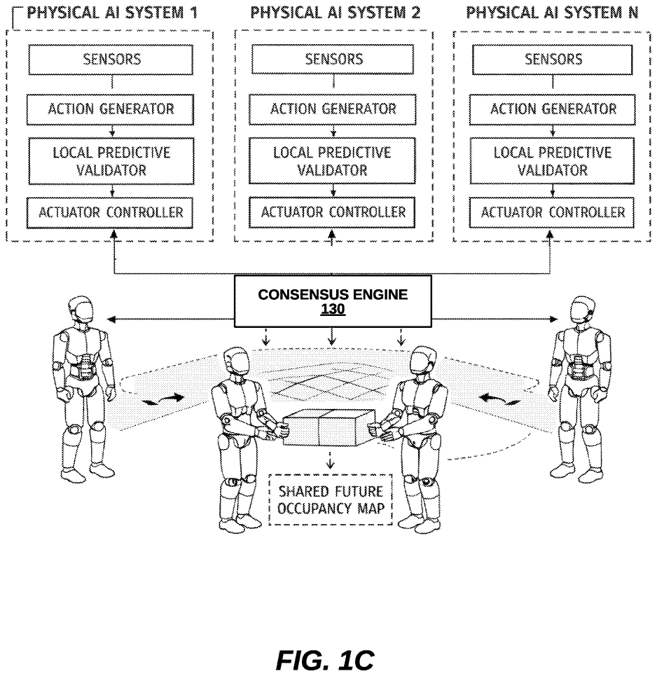

### I. Systems for Predictive Gating of Physical AI (FIGS. 1-4)

FIG. 1C illustrates a distributed physical artificial intelligence system 100 comprising a plurality of physical artificial intelligence systems or agents 110A-110N operating in a shared environment 101. The shared environment 101 may include a warehouse, workcell, factory floor, roadway, corridor, hospital, retail environment, loading zone, field site, public space, laboratory, airspace, waterways, or any other environment in which a plurality of embodied artificial intelligence systems may interact with each other, with humans, with shared tools, or with shared objects.

The plurality of physical artificial intelligence systems 110A-110N may include one or more humanoids, robot arms, drones, submersibles, autonomous mobile robots, autonomous vehicles, industrial machines, wearable robotic systems, field robots, or combinations thereof. In one embodiment, the systems are heterogeneous systems from different manufacturers or of varying capabilities. In another embodiment, the systems can have commonalities such as a common manufacturer, make use of a common protocol, have a common workflow of tasks, or be owned by the same entity. Each physical artificial intelligence system 110 may include one or more sensors, one or more processors, memory, an action generator, one or more local predictive validators, one or more communication interfaces, an actuator controller, and one or more physical actuators.

In some embodiments, each physical artificial intelligence system 110 generates a local candidate action responsive to task objectives, environmental context, model inference, learned policy output, planner output, operator input, or combinations thereof. The local candidate action may correspond to a low-level actuator command, a task-space motion, a short-horizon trajectory, a locomotion step, a gripper action, a tool action, a steering maneuver, a coordinated handoff move, a synchronized multi-agent action, or another physically executable proposal (see FIG. 1A).

In some embodiments, the local candidate action is generated by a decentralized swarm-planning system, a distributed multi-robot navigation policy, a graph-based coordination model, a reinforcement-learning-based controller, a trajectory-optimization engine, or another planner configured to output a locally feasible motion, path segment, or action proposal. The disclosed architecture does not require any particular planning modality and is configured to receive such candidate actions after local feasibility determination and before physical execution. Thus, the disclosed architecture may operate as a planner-independent release barrier that determines whether a locally feasible candidate action may actually be released for actuation when considered in view of cooperative, shared-context, or peer-validation conditions.

Each local candidate action is intercepted prior to motor release. In some embodiments, local predictive validation is first performed to estimate local risks such as collision, instability, excessive force, geofence violation, object loss, or unsafe human proximity. In some embodiments, a tactile-predictive validator is selectively invoked for contact-rich actions, including grasping, insertion, fragile-object handling, deformable-object handling, or tool use. In addition to local validation, the disclosed system performs shared-context evaluation among a plurality of physical artificial intelligence systems. For example, a local candidate action that is acceptable in isolation may nevertheless be delayed or denied when considered together with one or more peer candidate actions.

In some embodiments, a local planner, navigation policy, or trajectory generator may have already determined that a candidate action is collision-avoiding or otherwise locally feasible from the perspective of a respective physical artificial intelligence system. However, local feasibility alone may be insufficient to justify physical release. For example, the candidate action may remain unsafe, inefficient, or impermissible in combination with peer actions because of shared future occupancy conflict, carried-object envelope interaction, staged handoff mismatch, cooperative load-sharing imbalance, force-balance deficiency, or mutually exclusive workspace ownership. Accordingly, the disclosed system may deny or modify release even where an upstream decentralized planner has already approved the candidate action as locally feasible.

To support this cooperative evaluation, the plurality of physical artificial intelligence systems 110A-110N exchange shared-context information 150 through one or more communication links, mesh-network connections, edge coordinators, supervisory controllers, shared world-model services, decentralized networks, or other communication pathways. In some embodiments, the exchanged shared-context information comprises a compact descriptor rather than a full world-state transfer, such as reduced occupancy descriptors, envelope summaries, timing windows, intent descriptors, load-state summaries, uncertainty indicators, or other compressed cooperative metadata sufficient to support release authorization without requiring centralized replanning of the full swarm trajectory state.

In some embodiments, a consensus engine 160 evaluates the combined action set 165 associated with the plurality of local candidate actions. The consensus engine 160 may be implemented in a fully distributed manner across the systems, in a partially distributed manner with one or more designated coordinators, in a centralized edge process, in a shared world-model layer, or in combinations thereof.

The consensus engine 160 determines whether one or more authorization conditions are satisfied before simultaneous actuation is released. If the combined action set is authorized, one or more local actuation commands may be released. If the combined action set is not authorized, one or more local candidate actions may be delayed, staged, modified, synchronized, decomposed, rerouted, or rejected. In some embodiments the consensus engine 160 also considers already validated actions, to the extent they affect decisions on candidate actions.

### A. Local Candidate Actions and Shared-Context Information

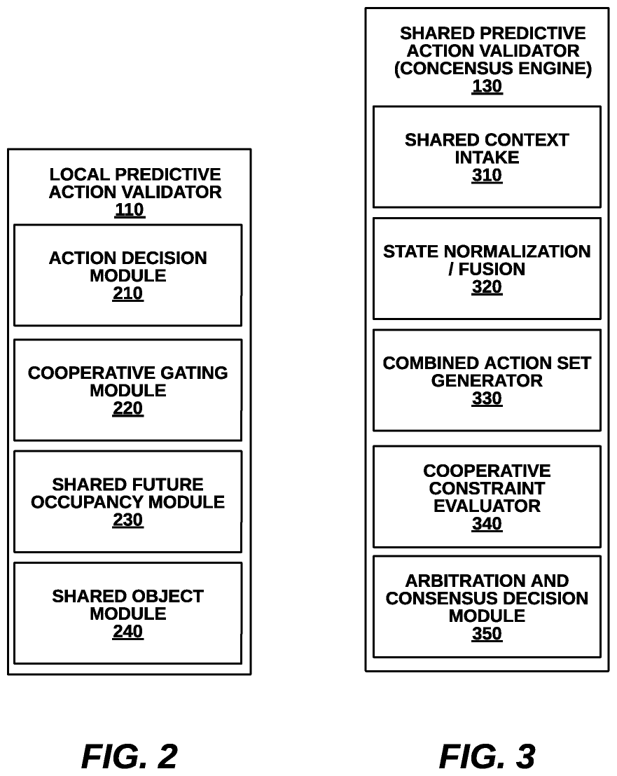

In FIG. 2, a more detailed block diagram of the local actuation validator 110 includes: an action decision module 210; a cooperating gating module 220, a shared future occupancy module 230, and a shared object module 240. In some embodiments, the action decision module 210 is configured to generate, select, or prioritize a local candidate action based on perception data, policy outputs, and current system state for submission to a pre-actuation validation process.

In some embodiments, the cooperative gating module 220 is configured to evaluate the local candidate action against cooperative constraints and peer validation inputs to determine whether the candidate action satisfies conditions for participation in a jointly permissible action set.

In some embodiments, the shared future occupancy module 230 is configured to predict and represent time-indexed future positions, volumes, or occupancy regions associated with one or more physical artificial intelligence systems for use in collision avoidance and cooperative authorization decisions.

In some embodiments, the shared object module 240 is configured to model, track, and evaluate the state of one or more shared objects, including load distribution, stability, and interaction constraints, to ensure that candidate actions involving the shared objects satisfy cooperative manipulation requirements.

A local candidate action comprises a machine-executable or machine-interpretable representation of a proposed physical behavior for a respective physical artificial intelligence system. In some embodiments, the local candidate action comprises low-level control content such as torque commands, joint position targets, joint velocity targets, wheel velocity targets, steering commands, thrust vectors, gripper-force commands, or other actuator-oriented content. In other embodiments, the local candidate action comprises higher-level content such as a path segment, end-effector pose, manipulator approach vector, load transfer maneuver, occupancy reservation, right-of-way claim, or cooperative task primitive.

The local candidate action may be accompanied by shared-context information. The shared-context information may include one or more of: (a) predicted occupancy map; (b) future trajectory; (c) local world-state projection; (d) actuation envelope; (e) tool envelope; (f) load-state projection; (g) object-state projection; (h) force envelope; (i) peer-readiness state; (j) task-stage identifier; (k) zone-reservation state; (l) handoff condition; (m) timing window; (n) predicted contact state; (o) intent descriptor; (p) uncertainty score; and (q) policy-relevant metadata. In more detail: (a) Predicted occupancy map may comprise a representation of one or more future spatial regions expected to be occupied by an agent, object, tool, or environment element over a defined time horizon; (b) Future trajectory may comprise a time-ordered sequence of predicted positions, poses, or motion states associated with execution of the local candidate action; (c) Local world-state projection may comprise an agent-specific prediction of environmental conditions, object states, and spatial relationships derived from local sensing and modeling; (d) Actuation envelope may comprise a spatial and temporal boundary defining the reachable or swept volume of an agent during execution of the local candidate action; (e) Tool envelope may comprise a representation of the spatial extent, orientation, and motion bounds of a tool or end-effector associated with the local candidate action (f) Load-state projection may comprise a predicted distribution of forces, weights, or loads applied by or to an agent or object during execution of the local candidate action; (g) Object-state projection may comprise a predicted pose, motion state, deformation state, or stability condition of an object affected by the local candidate action; (h) Force envelope may comprise a range or distribution of expected forces, torques, or contact pressures generated during execution of the local candidate action; (i) Peer-readiness state may comprise an indication of whether one or more peer agents are prepared, synchronized, or otherwise able to participate in a coordinated action; (j) Task-stage identifier may comprise a descriptor indicating a current phase, step, or subtask within a multi-stage operation associated with the local candidate action; (k) Zone-reservation state may comprise an indication of whether a spatial region, resource, or workspace is reserved, claimed, or available for use by one or more agents; (l) Handoff condition may comprise a state indicating readiness, alignment, or eligibility for transferring control, load, or possession of an object between agents; (m) Timing window may comprise a temporal interval within which execution of the local candidate action is intended, permitted, or coordinated with peer actions; (n) Predicted contact state may comprise an anticipated set of contact interactions including contact points, durations, forces, and surface conditions associated with the local candidate action; (o) Intent descriptor may comprise a semantic or structured representation of the purpose, objective, or expected outcome associated with the local candidate action; (p) Uncertainty score may comprise a quantitative or qualitative measure of confidence associated with predicted states, trajectories, or outcomes of the local candidate action; and (q) Policy-relevant metadata may comprise one or more parameters, labels, or contextual attributes used to evaluate compliance with safety, priority, or operational policies.

In one embodiment, the shared-context information includes a predicted occupancy representation indicating where an agent, tool, carried object, gripper, manipulator, or vehicle is expected to be over a future horizon. In another embodiment, the shared-context information includes an actuation envelope or swept-volume projection. In another embodiment, the shared-context information includes a load-state projection indicating anticipated load contribution or load balance on a shared object.

In some embodiments, the shared-context information is transmitted directly among peers. Peers can be a static or dynamically changing group of all robots of swarm, a group of designated robots (e.g., for a common task), or proximate robots within wireless range and thus more likely to physically affect each other. In other embodiments, the shared-context information is transmitted to and from a master autonomous AI agent a shared world-model service, edge coordinator, supervisory consensus process, or decentralized ledger structure.

In some embodiments, the disclosed system operates in communication-constrained swarm environments in which bandwidth is limited, latency varies, connectivity is intermittent, or different systems possess only partial observability of the shared environment. In such embodiments, release authorization may be based on partial shared-context exchange, asynchronous peer validation, confidence-weighted cooperative inputs, or staged release subject to continued permissibility as additional peer information becomes available.

### B. Combined Action Set Evaluation and Shared-Context Arbitration

In FIG. 3 a more detailed block diagram of the consensus engine 130 includes: a shared context intake 310; a state normalization/fusion 320, a combined action set generator 330, a cooperating constraint evaluator 340, and an arbitration and consensus decision module 350. In some embodiments, the shared context intake 310 is configured to receive and aggregate shared-context information from a plurality of physical artificial intelligence systems, including candidate actions, predicted states, and peer validation data.

In some embodiments, the state normalization and fusion module 320 is configured to normalize, align, and fuse heterogeneous state representations from the plurality of systems into a coherent shared context for joint evaluation.

In some embodiments, the combined action set generator 330 is configured to construct one or more candidate combined action sets based on the plurality of local candidate actions and the fused shared context.

In some embodiments, the cooperative constraint evaluator 340 is configured to evaluate the one or more candidate combined action sets against cooperative constraints, including collision avoidance, workspace exclusivity, timing coordination, and shared-object interaction requirements.

The combined action set comprises the plurality of local candidate actions considered together, optionally together with one or more previously reserved actions, persistent trajectory segments, active tool states, occupancy claims, or current object-state commitments.

The consensus engine 130 evaluates whether the combined action set satisfies one or more cooperative constraints. Such constraints may include, without limitation: (a) maintained separation distance; (b) maintained clearance from human or machine actors; (c) avoidance of future occupancy overlap; (d) mutually exclusive workspace ownership; (e) right-of-way compliance; (f) synchronized timing requirements; (g) line-sequencing readiness; (h) handoff readiness; (i) object-stability preservation; (j) cooperative force balance; (k) load-sharing balance; (l) zone exclusivity; (m) tool exclusivity; (n) shared-fixture occupancy; (o) communication-confirmation requirements; (p) policy-defined priority rules; and (q) confidence or uncertainty thresholds. In some embodiments, the cooperative constraints are evaluated as release constraints at a pre-actuation authorization layer and are distinct from upstream path-generation objectives, navigation heuristics, or trajectory-scoring functions used to generate the local candidate actions.

In some embodiments, a conflict is identified when the combined action set produces overlapping future occupancy, unsafe timing overlap, incompatible force application, object instability, failed zone exclusivity, or policy conflict. In response, one or more local candidate actions are delayed, modified, reordered, decomposed, rerouted, partially released, or rejected.

In some embodiments, the consensus engine 130 may permit a subset of systems to actuate while pausing or modifying another subset. Accordingly, simultaneous actuation need not mean all-or-nothing release for every candidate action.

In some embodiments, where the combined action set is not immediately permissible, the system resolves the conflict using one or more arbitration policies including priority rules, reservation rules, right-of-way rules, utility scoring, timing negotiation, zone ownership policies, task criticality policies, confidence-weighted selection, operator override, or consensus voting.

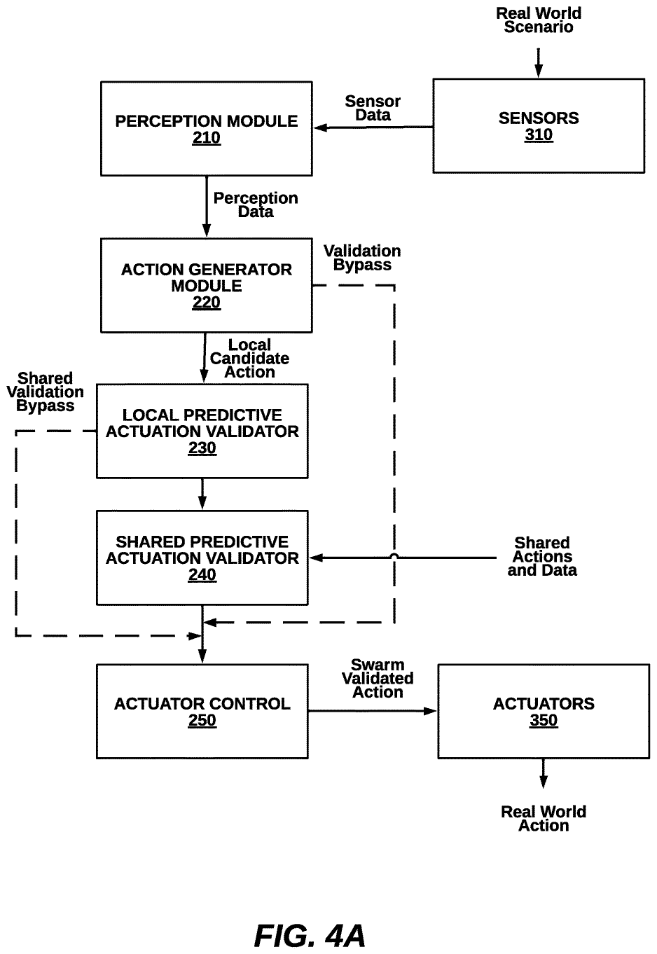

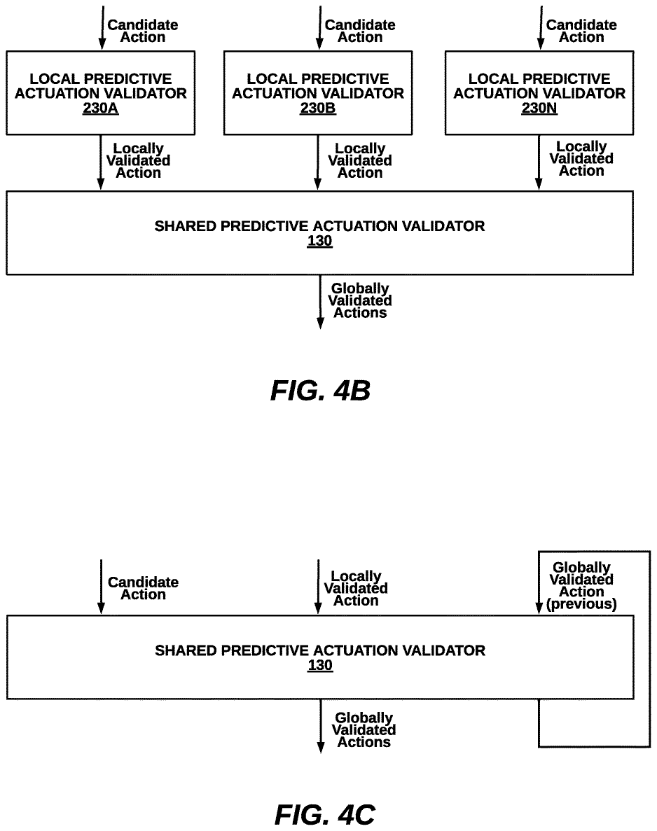

FIG. 4B is a block diagram illustrating the consensus engine 130 processing locally validated actions from a plurality of systems, according to an embodiment. By contrast, FIG. 4C is a block diagram illustrating the consensus engine 130 processing a variety of data including local candidate actions, including locally validated actions a candidate actions that have been locally validated, globally validated candidate actions as local candidate actions that have been swarm validated. In one case, globally validated actions may be fed back into the inferencing of a new set of local candidate actions and locally validated actions.

### C. Shared Future Occupancy Representation

In some embodiments, the shared future occupancy representation includes predicted future positions, swept volumes, time-indexed occupancy cells, probabilistic occupancy densities, or path-reservation intervals for a plurality of physical artificial intelligence systems.

The shared future occupancy representation 300 may be maintained in a grid, graph, map, scene representation, latent world-model representation, geometric planning structure, reservation table, or other data structure.

In one embodiment, each physical artificial intelligence system contributes a predicted occupancy region derived from its current local candidate action. One implementation also considers local validated actions in progress for actuation. The consensus engine then evaluates whether simultaneous actuation would cause a future occupancy conflict. In one example, a drone crossing maneuver and a humanoid lift maneuver may each be individually safe according to their respective local planners or validators, yet may nevertheless be impermissible in combination because a carried object enters a shared future occupancy corridor or because predicted occupancy overlap arises at different elevations or time offsets. In this manner, the shared future occupancy representation functions as a cooperative release-control layer that may override local feasibility determinations made upstream. For example, one of the devices can be delayed until clearance. The device can accept the delay or make different plans, such as occupying a different area without conflict.

In some embodiments, the shared future occupancy representation 300 is updated responsive to local candidate action changes, peer entry or exit from the environment, unexpected obstacle detection, policy updates, or revised world-state estimates.

In some embodiments, authorization is granted only while the shared future occupancy representation continues to indicate permissibility. If a proposed change causes a conflict before motor release or during a staged release process, authorization may be revoked, narrowed, or revised.

### 1. Shared Charging Station Occupancy

In some embodiments, the shared future occupancy representation further includes a shared charging-resource representation for a shared charging environment. In some embodiments, a local candidate action comprises a charging-related candidate action for a respective physical artificial intelligence system operating in the shared charging environment.

In some embodiments, the shared charging environment comprises one or more physical charging stations, each including one or more charging interfaces or ports configured to electrically or wirelessly couple to a respective physical artificial intelligence system. The charging interfaces may include conductive connectors, inductive charging pads, or resonant wireless charging elements. In some embodiments, the charging interfaces support one or more charging profiles including, for example, low-voltage charging of approximately 12 to 48 volts at approximately 5 to 50 amps, medium-voltage charging of approximately 48 to 400 volts at approximately 10 to 200 amps, or high-power charging above approximately 400 volts at approximately 100 to 500 amps, depending on system class, battery architecture, and energy requirements. In some embodiments, each charging station further includes one or more of port-status sensors, current regulators, voltage regulators, communication interfaces, reservation logic, queue-management logic, or port-allocation logic configured to coordinate access to the one or more charging interfaces among the plurality of physical artificial intelligence systems.

In some embodiments, the charging-related candidate action includes one or more of requesting immediate charging access, requesting partial charging access, requesting queue advancement, requesting reservation of a charging corridor, docking position, or charging bay, requesting temporary right-of-way to a charging interface, proposing deferred charging, proposing task transfer prior to charging, or proposing coordinated charging behavior with one or more peer systems.

In some embodiments, the charging-related candidate action is intercepted before physical movement toward a charging interface, before docking actuation, before reservation of a charging resource is finalized, or before release of a charging-claim signal, such that the charging-related candidate action remains provisional pending cooperative evaluation.

In some embodiments, the plurality of physical artificial intelligence systems exchanges shared-context information associated with the charging-related candidate action, including one or more of battery state, predicted depletion horizon, charging urgency, task criticality, charging-route occupancy, charging-bay reservation state, charger compatibility, estimated charging duration, peer readiness, or priority policy metadata. In some embodiments, the consensus engine determines whether the charging-related candidate action is authorized, delayed, modified, reordered, staged, or denied based on a combined action set and one or more cooperative constraints, including charger-bay contention, docking interference, charging-corridor blockage, queue conflict, charger-access deadlock, or priority-based resource allocation

### D. Shared Object-State and Load-Sharing Authorization

In some embodiments, a plurality of physical artificial intelligence systems jointly manipulate a common object. In such embodiments, release of local candidate actions may depend on a shared object-state authorization condition.

For example, two robot arms carrying a large panel may each propose locally valid grip motions. However, simultaneous actuation may still be unsafe unless load-sharing, force balance, orientation stability, and handoff timing satisfy one or more cooperative thresholds.

Accordingly, in some embodiments, the system maintains a shared object-state representation that includes one or more of object pose, predicted object pose, center-of-mass estimate, grip-point configuration, predicted load distribution, object fragility, compliance estimate, force balance, torsional imbalance, or instability likelihood.

The consensus engine evaluates whether the plurality of local candidate actions preserve the required object-stability authorization condition. If not, one or more local candidate actions may be staged, synchronized, slowed, modified, or denied. For instance, if the object is too heavy or large in dimensions, additional peers can be contacted for assistance or the task can be aborted altogether.

### E. Peer Validation Using Distinct Perspectives

In some embodiments, a proposing physical artificial intelligence system broadcasts a proposed local candidate action and a local state snapshot to one or more peer systems for peer validation.

Each peer system may evaluate the proposed local candidate action using one or more of its own sensors, its own local map, its own predicted occupancy model, its own simulation layer, or its own world model. Because the peer systems may have distinct spatial perspectives, different sensor geometries, different line-of-sight conditions, or different confidence estimates, the peer-validation process may reduce risk associated with localized blind spots, stale local state, or malicious local compromise. Accordingly, peer-side evaluation may reduce risk associated not only with geometric blind spots but also with localized overconfidence of learned navigation policies, stale local world models, or planner outputs generated from incomplete environmental observations

In some embodiments, each peer system returns a peer authorization output indicating whether the proposed local candidate action is permissible under one or more shared constraints. The peer authorization output may be binary, scored, weighted, confidence-valued, or policy-coded. In some embodiments, the peer authorization output includes one or more recommended modifications or conflict explanations.

In some embodiments, the peer authorization outputs comprise cryptographically verifiable authorization tokens, signed validation messages, authenticated votes, or other verifiable authorization artifacts.

In one embodiment, a proposing physical artificial intelligence system broadcasts a proposed local candidate action and a state snapshot to a plurality of peer physical artificial intelligence systems. Respective peers evaluate the proposal and, upon determining that applicable authorization conditions are satisfied, generate and transmit signed authorization tokens.

In some embodiments, an actuator controller of the proposing physical artificial intelligence system is cryptographically secured and logically interposed between the action generator and one or more physical actuators. The actuator controller aggregates received peer authorization outputs and verifies whether a required threshold condition has been satisfied.

The threshold condition may comprise a quorum, strict majority, weighted threshold, safety-class threshold, role-based threshold, Byzantine fault-tolerant threshold, or other o authorization threshold.

Only upon verification of the threshold condition does the actuator controller unlock one or more actuator pathways, motor drivers, brake-release circuits, torque-enable signals, or equivalent actuation-enabling elements.

In some embodiments, the cryptographically secured actuator controller prevents a higher-level action generator from bypassing the authorization layer. Thus, the disclosed architecture can physically isolate actuator execution from higher-level decision outputs until the required authorization condition is met.

In some embodiments, invalid, duplicate, stale, spoofed, revoked, or non-distinct authorization outputs are discarded. In some embodiments, authorization outputs are bound to a time window, candidate action identifier, environment identifier, peer identity, object identifier, or session identifier.

In some embodiments, the system tolerates one or more faulty, stale, malicious, compromised, or unresponsive peers by requiring a threshold of valid peer authorization outputs rather than unanimity.

Although some embodiments utilize cryptographically verifiable authorization outputs and threshold-based unlocking, other embodiments utilize non-cryptographic peer authorization outputs, shared-context arbitration, shared future occupancy evaluation, shared object-state evaluation, or combinations thereof. Thus, cryptographic motor unlocking is one implementation of the broader release-control architecture and need not be required in all embodiments.

### F. Staged, Partial, and Conditional Release

In some embodiments, the release decision is not limited to full release or full denial.

For example, an authorized release may comprise: (a) partial release of a first motion segment; (b) release subject to reduced speed; (c) release subject to reduced force; (d) release subject to increased clearance; (e) release subject to a narrower geofence; (f) release conditioned on peer readiness confirmation; or (g) release conditioned on continued shared future occupancy permissibility.

Accordingly, a local candidate action may be decomposed into smaller coordinated sub-actions, each separately authorized.

In some embodiments, decomposition into coordinated sub-actions permits progressive release in decentralized swarm environments where full multi-agent certainty is unavailable at a single instant. For example, a first motion segment may be released based on currently available cooperative data, while subsequent motion segments remain gated pending updated shared-context exchange, additional peer validation, or continued permissibility of a shared future occupancy representation.

In some embodiments, the system stores or otherwise records one or more of shared-context inputs, peer authorization outputs, shared future occupancy conflicts, shared object-state conflicts, release decisions, modification decisions, arbitration outcomes, or measured execution outcomes. Such stored or recorded information may be used to refine one or more predictive validators, world models, shared occupancy predictors, object-state estimators, consensus policies, arbitration policies, risk thresholds, or action-generation policies.

### G. Use Cases

In one example, a humanoid and a drone operate in a shared warehouse aisle. The drone proposes a crossing maneuver while the humanoid proposes a lift maneuver. The combined action set is evaluated against a shared future occupancy map. If maintained clearance and right-of-way conditions are satisfied, both actions may be released. If not, one action may be delayed or rerouted.

In another example, two robot arms jointly carry a fragile panel. Local lift commands are not released until the consensus engine verifies coordinated load sharing, maintained object stability, and synchronized motion timing.

In another example, multiple autonomous mobile robots seek access to a single charging corridor. The shared-context arbitration layer applies a corridor reservation policy and releases actuation only for the selected robot while delaying the others.

In another example, a plurality of aerial robots in a decentralized swarm each generate locally feasible trajectory segments using respective onboard navigation policies. Prior to motor release, the disclosed release-control architecture receives compact shared-context descriptors from the aerial robots and determines that, although the trajectory segments are locally feasible, a combined simultaneous action set would create an unsafe future occupancy convergence near a shared passage region. The disclosed system responsively delays release of at least one trajectory segment, stages release of another trajectory segment, or conditions release on updated peer authorization.

In another example, a proposing robot arm broadcasts a proposed motion to nearby peers. Distinct peers evaluate the proposal from different camera perspectives. Signed peer authorization outputs are returned. A cryptographically secured actuator controller unlocks the proposing robot's motors only when the required authorization threshold is met.

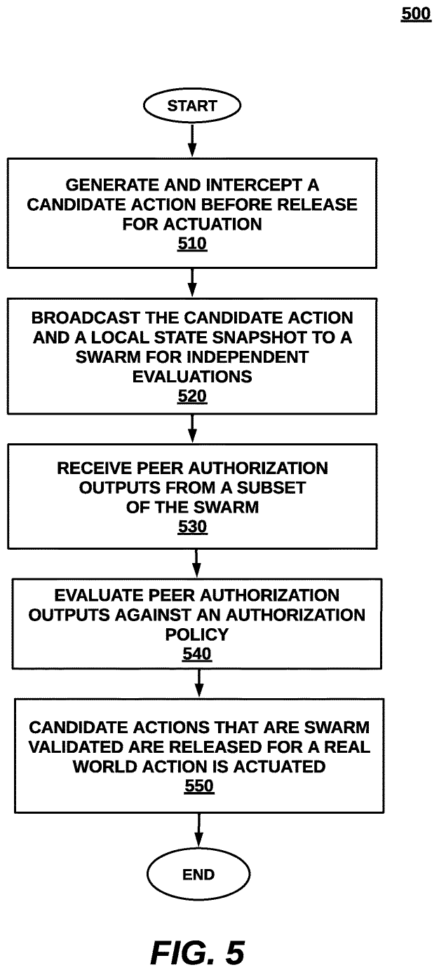

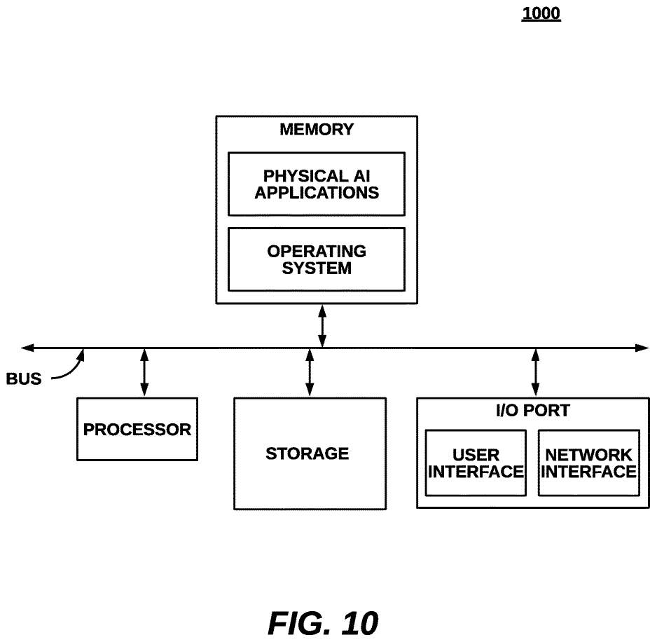

### II. Methods for Predictive Gating of Physical AI (FIGS. 5-10)

The disclosed systems may be implemented using one or more methods for intercepting, evaluating, coordinating, and selectively releasing candidate actions before physical execution. The order of steps may vary, and steps may be omitted, added, repeated, or combined in different embodiments.

### A. Method for Peer Validation and Threshold Authorization

FIG. 5 is a flow diagram illustrating a method 500 for peer validation and threshold authorization for actuation gating in a distributed swarm of physical artificial intelligence systems, according to an embodiment.

In step 510, a first physical artificial intelligence system generates a candidate action. In some embodiments, the candidate action is generated by a learned policy, planner, navigation model, reinforcement-learning controller, graph-based coordination model, optimization engine, or another decision model. The first physical artificial intelligence system intercepts the candidate action prior to motor release so that the candidate action remains a proposal rather than an immediately executable motor command.

In step 520, the first physical artificial intelligence system broadcasts the candidate action and a local state snapshot to a plurality of peer physical artificial intelligence systems. In some embodiments, the local state snapshot includes one or more of local sensor state, local map state, predicted occupancy state, object-state information, timing information, uncertainty information, or combinations thereof. a subset of the plurality of peer physical artificial intelligence systems independently evaluates the candidate action. In some embodiments, a respective peer physical artificial intelligence system performs such evaluation using one or more of a distinct spatial perspective, distinct sensor geometry, distinct predicted occupancy map, distinct local world model, distinct simulation pipeline, or combinations thereof.

In step 530, the first physical artificial intelligence system receives peer authorization outputs from the subset of peer physical artificial intelligence systems. In some embodiments, a respective peer authorization output indicates that a respective peer physical artificial intelligence system independently evaluated the candidate action and verified one or more physical safety criteria. In various embodiments, the peer authorization outputs are binary, scored, weighted, confidence-valued, policy-coded, explanatory, or combinations thereof.

In step 540, an actuator controller, consensus module, or other authorization component aggregates or otherwise evaluates the received peer authorization outputs. In some embodiments, the actuator controller or associated authorization component determines whether the received peer authorization outputs satisfy a predetermined threshold authorization condition. In some embodiments, the predetermined threshold authorization condition comprises a quorum, strict majority, weighted threshold, role-based threshold, safety-class threshold, Byzantine fault-tolerant threshold, or another threshold condition.

In step 550, responsive to determining that the predetermined threshold authorization condition is satisfied, actuation associated with the candidate action is released. In some embodiments, a secured actuator controller physically unlocks one or more actuators of the first physical artificial intelligence system to execute the candidate action.

In some embodiments, if the predetermined threshold authorization condition is not satisfied, actuation associated with the candidate action remains blocked, withheld, delayed, modified, staged, decomposed, rerouted, or rejected. In some embodiments, the system requests additional peer validation before making a release decision.

In some embodiments, the peer authorization outputs comprise cryptographically verifiable authorization tokens, signed validation messages, authenticated votes, or other verifiable authorization artifacts. In such embodiments, a cryptographically secured actuator controller verifies one or more of authenticity, freshness, non-duplication, identity association, or combinations thereof before determining whether the threshold authorization condition is satisfied. In some embodiments, responsive to determining that the threshold authorization condition is satisfied using the cryptographically verifiable authorization artifacts, the cryptographically secured actuator controller physically unlocks one or more actuators of the first physical artificial intelligence system.

In other embodiments, the peer authorization outputs are non-cryptographic and are nevertheless sufficient to support threshold authorization and release control. Accordingly, the disclosed peer validation and threshold authorization architecture is not limited to cryptographic consensus implementations, although cryptographic implementations may provide enhanced authenticity, tamper resistance, fault tolerance, or security in some deployments.

### B. Method for Shared-Context and Combined-Action-Set Gating

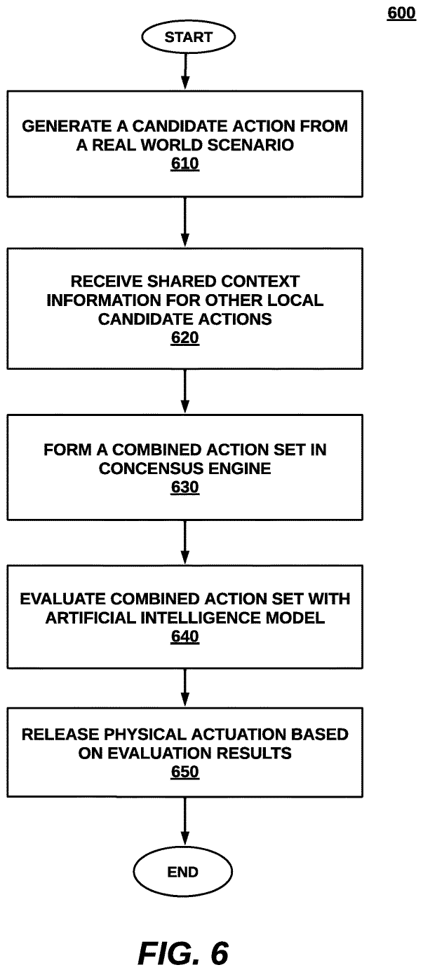

FIG. 6 is a flow diagram illustrating a method 600 for cooperative actuation gating among a plurality of physical artificial intelligence agents, according to an embodiment.

In step 610, each of a plurality of physical artificial intelligence agents receives or generates a respective local candidate action.

In step 620, the plurality of physical artificial intelligence agents exchanges shared-context information corresponding to the respective local candidate actions. In some embodiments, the shared-context information includes one or more of predicted occupancy, future trajectory, actuation envelope, tool envelope, load-state projection, object-state projection, timing window, right-of-way state, peer readiness, uncertainty state, intent descriptor, or combinations thereof.

In step 630, a consensus engine forms a combined action set associated with the respective local candidate actions. In some embodiments, the combined action set further includes one or more previously reserved actions, persistent trajectory segments, active tool states, occupancy claims, current object-state commitments, or combinations thereof. In step 640, the consensus engine evaluates whether the combined action set satisfies one or more cooperative constraints. In some embodiments, the cooperative constraints include one or more of collision constraints, maintained clearance constraints, future occupancy overlap constraints, object-stability constraints, load-sharing constraints, zone exclusivity constraints, right-of-way constraints, synchronized timing constraints, mutually exclusive workspace constraints, communication-confirmation constraints, or combinations thereof.

In some embodiments, step 640 includes evaluating the combined action set across a plurality of cooperative dimensions at a pre-actuation release layer rather than at an upstream path-generation layer. For example, the consensus engine may evaluate spatial overlap of predicted occupancy regions, temporal overlap of motion windows, sequencing compatibility between task stages, shared-object stability under concurrent force application, load-balance sufficiency, zone-reservation conflicts, right-of-way priority, communication completeness, or confidence-weighted agreement among peer authorization outputs.

In some embodiments, such evaluation is performed using one or more artificial-intelligence models including learned world models, graph neural networks, trajectory-risk models, occupancy-prediction models, object-stability models, force-balance models, multimodal models, language-guided reasoning models, or combinations thereof. In some embodiments, inferencing input to such models is generated from structured cooperative data including one or more of candidate action descriptors, predicted trajectories, occupancy descriptors, timing windows, task-stage identifiers, object-state descriptors, peer-readiness indicators, uncertainty values, policy metadata, or combinations thereof. In some embodiments, the structured cooperative data is assembled into a model-consumable prompt, schema, graph representation, tensor representation, feature vector, or other structured inferencing input so that the one or more artificial-intelligence models generate an authorization evaluation, conflict score, release recommendation, staged-release recommendation, or other cooperative decision output. In some embodiments, the consensus engine applies one or more deterministic rules, learned policies, simulation-based validators, scoring functions, threshold comparisons, or weighted arbitration routines to the resulting model outputs in order to determine whether authorization should be granted for the full combined action set, for only a subset of local candidate actions, or only for a staged or conditional release sequence.

In step 650, responsive to determining that the combined action set satisfies the one or more cooperative constraints, physical actuation is released for at least one of the plurality of physical artificial intelligence agents. Responsive to determining that the combined action set does not satisfy the one or more cooperative constraints, one or more respective local candidate actions are delayed, modified, reordered, decomposed, rerouted, synchronized, partially released, or rejected.

In some embodiments, the consensus engine is implemented in a distributed manner across the plurality of physical artificial intelligence agents, in an edge coordinator, in a supervisory controller, in a shared world-model service, or in a hybrid combination thereof.

### C. Method for Shared Future Occupancy Authorization

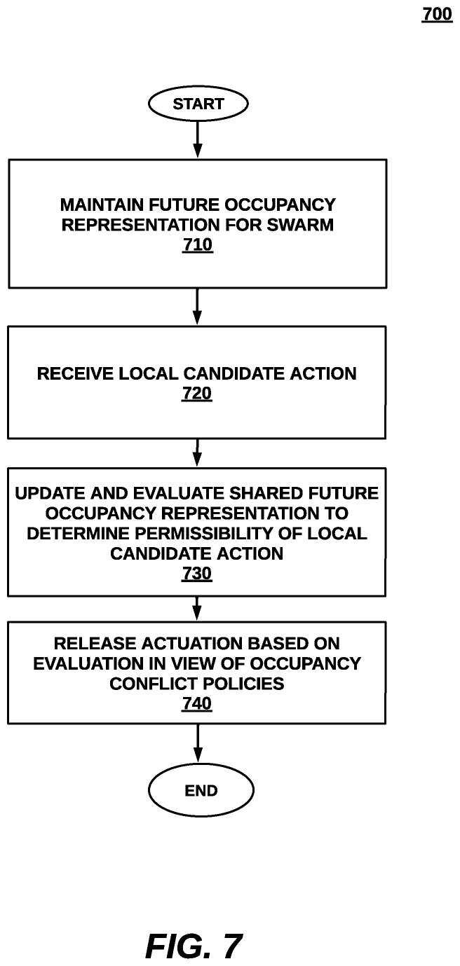

FIG. 7 is a flow diagram illustrating a method 700 for shared future occupancy authorization, according to an embodiment.

In step 710, a system maintains a shared future occupancy representation for a plurality of physical artificial intelligence agents. In some embodiments, the shared future occupancy representation includes one or more of predicted future positions, swept volumes, time-indexed occupancy cells, probabilistic occupancy densities, path-reservation intervals, or combinations thereof.

In step 720, the system receives one or more proposed local action changes, local candidate actions, updated trajectory segments, or updated occupancy descriptors from one or more of the plurality of physical artificial intelligence agents. The system updates the shared future occupancy representation responsive to the proposed local action changes. In some embodiments, the updating accounts for one or more of peer entry into the environment, peer exit from the environment, unexpected obstacle detection, policy updates, revised world-state estimates, or combinations thereof.

In step 730, the system evaluates the updated shared future occupancy representation to determine whether simultaneous actuation for one or more of the plurality of physical artificial intelligence agents remains permissible. In one embodiment, the shared future occupancy representation comprises a predictive spatiotemporal model of object position, agent trajectories, contact regions, and environmental constraints over a future time horizon. A validation engine processes the representation to detect conflicts, including spatial overlap, collision risk, unstable contact configurations, or violation of safety margins. The evaluation may include deterministic analysis, such as geometric intersection testing, kinematic constraint validation, temporal separation enforcement, and threshold-based safety rules. In addition, the evaluation may incorporate one or more machine-learned predictive models configured to assess dynamic feasibility and coordination risk, including likelihood of collision, instability, oscillation, or interference among agents. The machine-learned models may be trained using simulation-generated and/or real-world datasets comprising multi-agent interaction trajectories labeled with success, failure, or stability outcomes, and may include supervised, self-supervised, or reinforcement learning approaches. Inputs to the models may include encoded occupancy grids, trajectory vectors, force estimates, and contextual state derived from the shared context exchange. Based on the combined deterministic and learned evaluation, the system determines whether concurrent execution of the candidate actions is permissible, and if not, selectively delays, modifies, reorders, or suppresses one or more agent actions to maintain coordinated and stable operation.

In some embodiments, the evaluation in step 730 further includes evaluating shared charger occupancy within a shared charging environment. For example, the updated shared future occupancy representation may include one or more charging bays, docking positions, charging corridors, queue positions, charging pads, wireless charging zones, connector reach envelopes, or charger-approach regions, together with predicted arrival times, predicted dwell times, charging durations, charging urgency values, and reservation states associated with a plurality of physical artificial intelligence systems. In some embodiments, the system evaluates whether one or more charging-related candidate actions are permissible by determining whether simultaneous movement toward a shared charger would create charger-bay contention, docking interference, charging-corridor blockage, unsafe queue convergence, charger-access deadlock, or impermissible delay for a higher-priority system. In some embodiments, such evaluation includes one or more deterministic rules and one or more machine-learned models configured to infer charging-resource conflict risk, queue instability, or cooperative charging feasibility based on one or more of battery state, predicted depletion horizon, task criticality, charger compatibility, partial-charge sufficiency, peer readiness to vacate a charging position, or policy-defined charging priority. Based on the evaluation, the system may authorize, delay, reorder, stage, narrow, or deny one or more charging-related candidate actions, including movement toward a charging interface, docking actuation, reservation of a charging resource, or release of a charging-claim signal, so that shared charger occupancy remains coordinated and safe.

In step 740, responsive to determining that the updated shared future occupancy representation indicates permissibility, the system authorizes or maintains authorization for simultaneous actuation. Responsive to determining that the updated shared future occupancy representation indicates a conflict, overlap, or impermissible convergence, the system denies, narrows, delays, stages, or revokes authorization for simultaneous actuation for one or more of the plurality of physical artificial intelligence agents. In some embodiments, the shared future occupancy representation functions as a cooperative release-control layer that overrides one or more upstream local feasibility determinations.

### D. Method for Shared Object-State and Load-Sharing Authorization

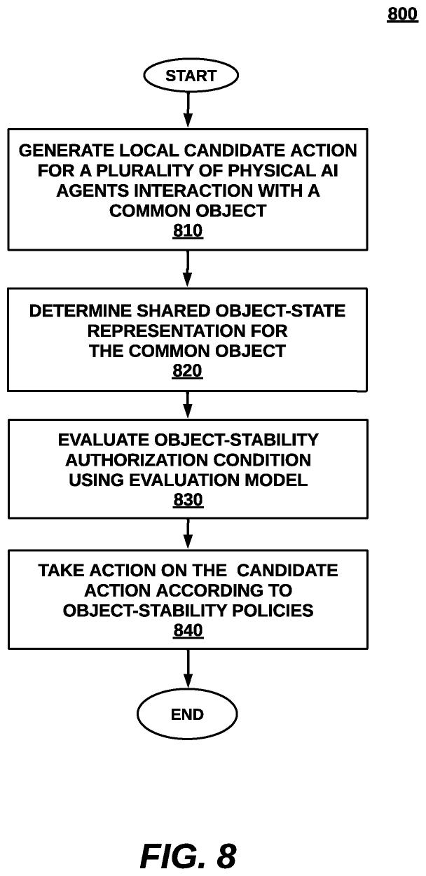

FIG. 8 is a flow diagram illustrating a method 800 for shared object-state and load-sharing authorization, according to an embodiment.

In step 810, the system receives local candidate actions for a plurality of physical artificial intelligence agents jointly manipulating, carrying, supporting, stabilizing, handing off, or otherwise interacting with a common object.

In step 820, the system determines or updates a shared object-state representation corresponding to the common object. In some embodiments, the shared object-state representation includes one or more of object pose, predicted object pose, center-of-mass estimate, grip-point configuration, predicted load distribution, object fragility, compliance estimate, force balance, torsional imbalance, instability likelihood, handoff readiness, or combinations thereof.

In step 830, the system determines whether a load-sharing or object-stability authorization condition is satisfied for a common object based on a combined evaluation of deterministic physical constraints and learned predictive modeling. In one embodiment, a validation engine aggregates candidate actions generated by a plurality of systems from a shared context exchange, the shared context exchange comprising a structured representation of object state, environmental conditions, and proposed actuation parameters. The validation engine evaluates one or more deterministic criteria including force thresholds, contact geometry, kinematic feasibility, collision avoidance, and stability margins. In addition, the validation engine applies one or more machine-learned models trained on simulation and/or real-world interaction data to predict object behavior under the combined candidate actions, including slip probability, deformation risk, load imbalance, and coordination conflict among systems. The machine-learned models may comprise neural networks, graph-based models, or other predictive inference engines trained using labeled success and failure outcomes from multi-agent manipulation scenarios. Based on the combined deterministic and learned evaluation, the system generates an authorization decision indicating whether the candidate actions satisfy a load-sharing condition and maintain object stability. If the authorization condition is satisfied, execution of the coordinated actions is permitted; otherwise, one or more candidate actions are modified, rejected, or deferred, and updated candidate actions may be re-evaluated in a subsequent iteration.

In step 840, responsive to determining that the load-sharing or object-stability authorization condition is satisfied, the system releases local actuation commands for one or more of the plurality of physical artificial intelligence agents. Responsive to determining that the load-sharing or object-stability authorization condition is not satisfied, the system delays, stages, synchronizes, slows, modifies, decomposes, or denies one or more of the local candidate actions.

In some embodiments, the load-sharing or object-stability authorization condition is reevaluated during execution of a staged release sequence.

### F. Method for Branching, Staged, and Conditional Release Control

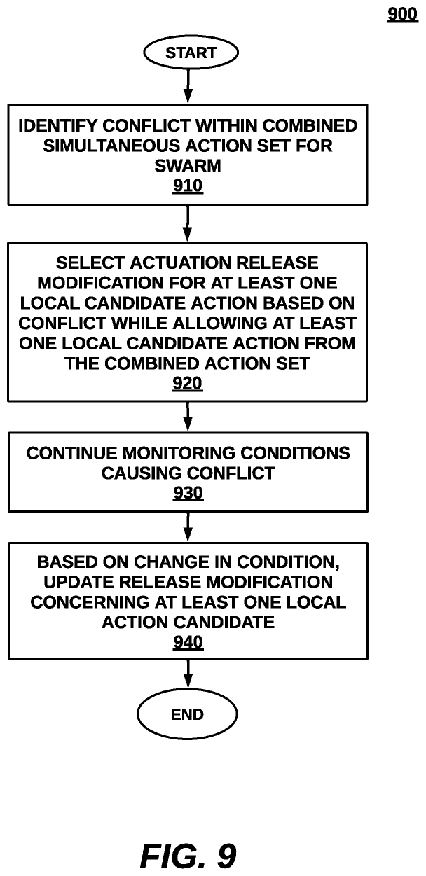

FIG. 9 is a flow diagram illustrating a method 900 for branching, staged, and conditional release control, according to an embodiment.

In step 910, the system identifies a conflict within a combined simultaneous action set for a plurality of physical artificial intelligence agents. In some embodiments, the conflict includes one or more of future occupancy conflict, timing conflict, incompatible force application, object instability, zone exclusivity conflict, policy conflict, communication deficiency, or combinations thereof.

In step 920, the system selects one or more release modifications responsive to identifying the conflict. In some embodiments, the one or more release modifications comprise delay, staged release, partial release, decomposition into coordinated sub-actions, rerouting, reduced-speed release, reduced-force release, increased-clearance release, narrower-geofence release, or conditional release subject to continued permissibility of a shared future occupancy representation. The system controls actuation of one or more of the plurality of physical artificial intelligence agents according to the selected one or more release modifications. Where decomposition into coordinated sub-actions is selected, the system separately authorizes one or more sub-actions while withholding one or more other sub-actions pending updated cooperative information.

In step 930, where conditional release is selected, the system monitors one or more conditions including continued permissibility of a shared future occupancy representation, updated peer validation, object-stability, peer readiness confirmation, or combinations thereof.

In step 940, responsive to a change in the monitored one or more conditions, the system maintains, modifies, narrows, pauses, or revokes authorization for one or more subsequent sub-actions or motion segments.

In some embodiments, progressive release is thereby achieved in decentralized swarm environments where full multi-agent certainty is unavailable at a single instant.

### III. Computing Environment and Generalities (FIG. 11)

In FIG. 11, a computing environment 900 implementable by various components of FIG. 1A and B includes a memory storing network applications and an OS, a processor, a storage drive, and an I/O port including a user interface and a network interface, coupled by a bus. The processor executes instructions to perform the operations described herein and may comprise a CPU, GPU, NPU, or an array of interconnected processors. In some embodiments, the computing environment includes AI-optimized hardware, such as cooperating CPUs and GPUs or other hardware accelerators, for local SLM execution and edge inferencing.

The disclosed modules may be implemented in software, firmware, hardware, or combinations thereof. One or more functions may be embodied as distributed runtime modules, local controllers, supervisory controllers, edge services, world-model services, trusted actuation controllers, or consensus services.

The disclosed techniques may be used in fully autonomous, semi-autonomous, teleoperated, supervised-autonomy, or human-in-the-loop systems.

The disclosed techniques are not limited to any particular communication protocol, cryptographic scheme, control framework, actuator type, morphology, or world-model representation.

1. A computer-implemented method for cryptographic consensus actuation gating in a distributed swarm of physical artificial intelligence systems, the method comprising:
generating, by a first physical artificial intelligence system, a candidate action;
intercepting the candidate action prior to motor release;
broadcasting the candidate action and a local state snapshot to a plurality of peer physical artificial intelligence systems;
receiving a plurality of cryptographic validation tokens from a subset of the peer physical artificial intelligence systems, wherein each cryptographic validation token indicates that a respective peer physical artificial intelligence system independently simulated the candidate action and verified physical safety criteria;
aggregating, at a cryptographically secured actuator controller of the first physical artificial intelligence system, the received cryptographic validation tokens;
determining whether the aggregated cryptographic validation tokens satisfy a predetermined consensus threshold; and
responsive to determining the predetermined consensus threshold is satisfied, physically unlocking one or more actuators of the first physical artificial intelligence system to execute the candidate action.

2. The method of claim 1, wherein the respective peer physical artificial intelligence system independently simulates the candidate action utilizing a spatial perspective derived from sensors physically distinct from the first physical artificial intelligence system.

3. The method of claim 1, wherein the predetermined consensus threshold comprises a Byzantine fault-tolerant quorum requiring mathematically verified tokens from a strict majority of authenticated peer physical artificial intelligence systems within a local mesh network.

4. (canceled)

5. (canceled)

6. (canceled)

7. (canceled)

8. (canceled)

9. (canceled)

10. (canceled)

11. (canceled)

12. A computer-implemented method comprising:
maintaining a shared future occupancy representation for present and future locations associated with each of a plurality of physical artificial intelligence agents;
receiving a local candidate action from at least one of the plurality of physical artificial intelligence agents, wherein the local candidate action concerns a present location and/or a future location for the at least one of the plurality of physical artificial intelligence agents;
updating the shared future occupancy representation responsive to the at least one proposed local candidate action; and
using the shared future occupancy representation to authorize or deny actuation of the local candidate action for the at least one of the plurality of physical artificial intelligence agents.

13. The method of claim 12, wherein using the shared future occupancy representation further comprises evaluating shared charger occupancy for the plurality of physical artificial intelligence agents competing for access to a shared charging resource, and authorizing or denying movement toward the shared charging resource for the at least one of the plurality of physical artificial intelligence agents based on one or more of predicted arrival times, charging duration, charging urgency, charging-resource reservation state, or charger-access conflict conditions.

14. The method of claim 12, wherein the shared future occupancy representation considers present and future locations according to a specific time of a plurality of times.

15. A computer-implemented method comprising:
receiving a plurality of local candidate actions for a plurality of physical artificial intelligence agents jointly manipulating a common object, wherein the local candidate action concerns a specific one of the plurality of physical artificial intelligence agents using a local actuation controller to manipulate the common object;
determining whether a load sharing or object stability authorization condition is satisfied for the common object in view of the plurality of local candidate actions; and
releasing one or more of the local actuation commands to the local actuation controller only upon determining that the load-sharing or object-stability authorization condition is satisfied, and selectively gating one or more of the local authorization commands to the local actuation controller upon determining that the load-sharing or object-stability authorization condition is not satisfied.

16. The method of claim 15, wherein determining whether the load-sharing or object-stability authorization condition is satisfied comprises evaluating one or more of predicted load distribution, force balance, object pose stability, object pose position, grip-point configuration, torsional imbalance, or handoff readiness.

17. The method of claim 15. wherein determining comprises determining that the load-sharing or object-stability authorization condition is not satisfied for the common object, and modifying at least one of the one or more local actuation commands that satisfies at least one of the conditions.
